(19) United States
(12) Patent Application Publication
(10) Pub. No.: US 2003/0065582 A1
(43) Pub. Date: Apr. 3, 2003

(54) Method and apparatus for facilitating switchgear component purchasing transactions

(76) Inventor: David J. Lin, Knightdale, NC (US)

Correspondence Address: Harold C. Moore, Maginot, Moore & Bowman, Bank One Center/Tower, 111 Monument Circle, Suite 3000, Indianapolis, IN, 46204-5115, US

(21) Appl. No.: 10/208,138

(22) Filed: Jul. 29, 2002

Related U.S. Application Data
(60) Provisional application No. 60/325,059, filed on Sep. 25, 2001.

(51) Int. Cl. G06F 17/60

(52) U.S. Cl. 705/26

(57) ABSTRACT

A method of specifying an electrical switchgear system includes providing a first signal to a first processing circuit indicative of a selection of a first switchgear subsystem type from a plurality of switchgear subsystem types. In addition, the method includes providing a second signal to the first processing circuit indicative of a selection of a second switchgear subsystem type from the plurality of switchgear subsystem types. Thereafter a schematic file is updated by incorporating first switchgear subsystem schematic data and second switchgear subsystem schematic data.

This application claims the benefit of U.S. Provisional Patent Application Serial No. 60/325,059, filed Sep. 25, 2001, and which is incorporated by reference herein.

### BACKGROUND OF THE INVENTION

The present invention relates generally to the field of switchgear for electrical distribution networks, and in particular, to methods and apparatus for facilitating the purchasing of switchgear components and systems.

Commercial, industrial and other large facilities typically receive medium to high voltage electrical power and then distribute the power internally using switchgear. In general, switchgear includes electrical and electronic components, as well as associated mechanical structures and devices, that assist in the distribution of electrical power. Such devices include general feeder subsystems, transformer feeder subsystems, motor feeder subsystems, single and dual source subsystems, bus ties, and other systems. Switchgear subsystem components include, by way of nonlimiting example, circuit breakers, surge arrestors, current transformers, voltage transformers, control switches, fuses, protective relays, meters, and indicators.

Switchgear subsystems are often housed in cabinets that include special arc venting and other safety features that protect the facility in the event of a catastrophic malfunction within the electrical distribution subsystem. Many facilities include several subsystems, housed in multiple cabinets, that provide feeders to various portions or branches of the facilities' electrical system. Typically, each subsystem includes a circuit breaker that is configured to isolate the attached branch of the electrical system from the utility feeder line in the case of an electrical fault.

For various reasons, the switchgear purchasing process has historically required extensive involvement of a number of professionals, including sales professionals and application engineers. Accordingly, in addition to the cost of the switchgear equipment itself, costs were incurred, either directly or indirectly, due to the labor involved in the purchasing process.

For example, a typical switchgear purchasing transaction involved a sales professional who would educate the customer on the features and nature of the products available through the switchgear supplier and/or manufacturer (hereinafter the “switchgear provider”). Once a product line was selected, an application engineer would typically coordinate with the customer to determine which specific switchgear products or subsystems of the product line would best suit the needs of the customer. For example, such a process might result in a determination that the customer's needs are best met by two incoming feeders, a tie breaker, two motor feeders, and a transformer feeder. This determination typically required an application engineer that was familiar with the switchgear products, the options available on the products, as well as the voltage and current carrying capacities of the products. The application engineer further worked with other personnel of the switchgear provider to generate schematics and mechanical blueprints of the entire system.

The costs of the application engineering services, including preparation of the drawings and schematics, as well as the sales costs, all contribute to the final cost of the purchased switchgear. There is a need, therefore, for a method of purchasing switchgear that eliminates or reduces at least some of the costs associated with the switchgear purchasing process.

### SUMMARY OF THE INVENTION

The present invention overcomes the above stated needs, as well as others, by providing a method and system for specifying a switchgear system purchase that automatically generates schematic information and/or system price information. Such tools may be used by a customer to price and/or develop a switchgear purchase with greatly reduced salesperson and application engineer involvement.

In a first embodiment of the invention, a method of specifying an electrical switchgear system includes providing a first signal to a first processing circuit indicative of a selection of a first switchgear subsystem type from a plurality of switchgear subsystem types. In addition, the method includes providing a second signal to the first processing circuit indicative of a selection of a second switchgear subsystem type from the plurality of switchgear subsystem types. Thereafter a schematic file is updated by incorporating first switchgear subsystem schematic data and second switchgear subsystem schematic data.

A second embodiment of the present invention is a system for facilitating the selection of electrical switchgear that includes a memory and a processing circuit. The memory stores schematic data for a plurality of switchgear subsystem types. The processing circuit is operably coupled to the memory. The processing circuit is operable to receive a first signal indicative of a selection of a first switchgear subsystem type from the plurality of switchgear subsystems, and receive a second signal indicative of a selection of a second switchgear subsystem from the plurality of switchgear subsystems. The processing circuit is further operable to update a system schematic file using schematic data for the first switchgear subsystem type and schematic data for the second switchgear subsystem type.

The above-described embodiments thus reduce the labor involved in a switchgear purchasing transaction by automating select portions of the transaction.

The above discussed features and advantages, as well as others, may readily be ascertained by those of ordinary skill in the art by reference to the following detailed description and accompanying drawings.

### BRIEF DESCRIPTION OF THE DRAWINGS

FIG. 1 shows a schematic block diagram of an exemplary system for facilitating the selection of electrical switchgear according to the present invention;

FIG. 2 shows a flow diagram of an exemplary set of operations that facilitate the generation of switchgear purchasing transaction according to the present invention;

FIG. 3 shows in further detail an exemplary set of operations that may be used to carry a subsystem definition operation in accordance with one aspect of the present invention;

FIG. 4 shows in further detail an exemplary set of operations that may be used to generate a switchgear system line-up in accordance with the present invention;

FIG. 5 shows in further detail an exemplary set of operations that generate schematic information and mechanical drawing information of a system generated using the operations of FIG. 4;

FIGS. 6 and 7 show representation of shell schematic files for two different generic subsystem types in accordance with the present invention;

FIG. 8 shows a representative block diagram of a library subsystem definition data file generated in accordance with the present invention;

FIG. 9 shows a representation of an exemplary output of a schematic file of a system line-up generated in accordance with the present invention; and

FIG. 10 shows a representation of an exemplary output of a mechanical drawing file of the system line-up of FIG. 9.

### DETAILED DESCRIPTION

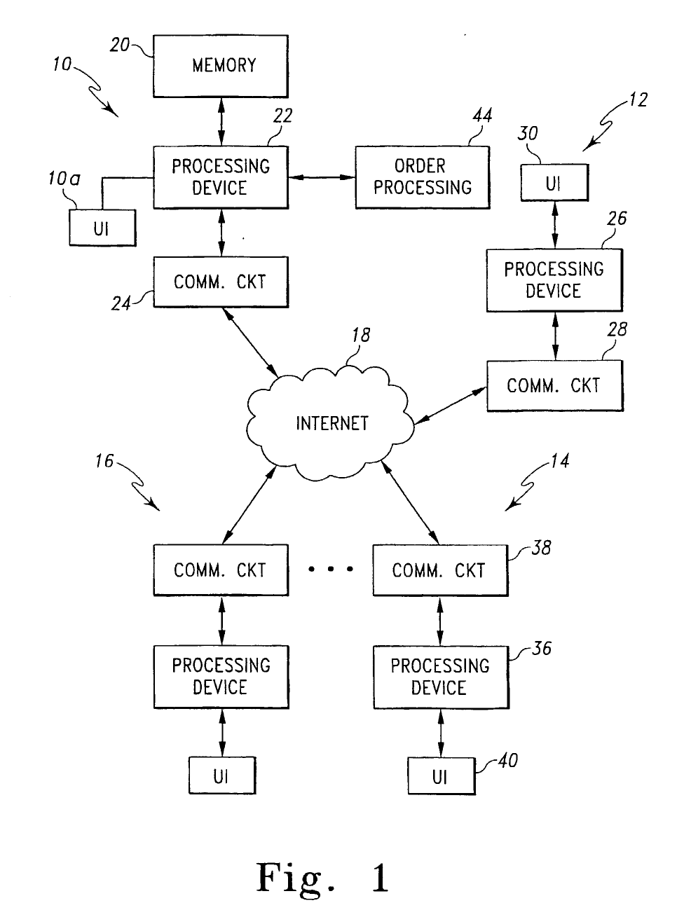

FIG. 1 shows a system 10 for facilitating the selection of electrical switchgear. The system 10 in the exemplary arrangement of FIG. 1 is operably coupled to communicate with plural remote processing systems, exemplified by the remote processing systems 12, 14 and 16, via an internetwork, which may suitably be the Internet 18. Communication between the system 10 and the remote processing systems 12, 14 and 16 may be accomplished using the World Wide Web, employing a web-site that is located at, or hosted by, the system 10.

The system 10 includes a memory 20, a processing circuit 22, and a communication circuit 24. The memory 20 stores various data associated with predefined switchgear subsystem types. A switchgear subsystem is typically a breaker system that connects between a medium or high voltage bus and a branch circuit. The branch circuit generally defines the type of switchgear subsystem that should be employed. For example, a branch circuit that provides power to industrial motors would employ a motor feeder subsystem type. Other subsystems types include general purpose feeders, incoming feeders, and transformer feeders. Such switchgear subsystems are known.

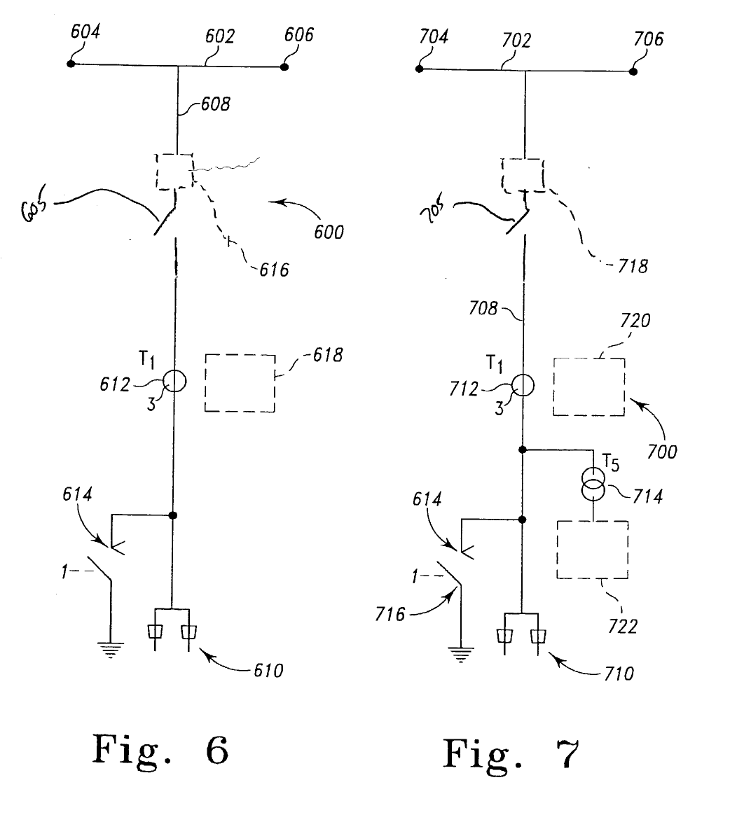

At least some of the data stored in the memory 20 is schematic data for the predefined switchgear subsystem types. FIGS. 6 and 7 show schematic representations of the schematic data stored for the predefined switchgear subsystem types in the memory 20. FIG. 6 shows a schematic representation of a transformer feeder subsystem and FIG. 7 shows a schematic representation of an incoming feeder subsystem type. The schematics of FIGS. 6 and 7 have blanks which allow for user configuration. Further details regarding the schematic representations of FIGS. 6 and 7 are provided further below.

The processing circuit 22 is operably coupled to the memory 20 to retrieve information therefrom and to store information therein. The processing circuit 22 is operable to receive signals indicative of selections of plural switchgear subsystem types and update a system schematic file using schematic data for the plural switchgear subsystem types. For example, the processing circuit 22 is operable to receive signals that indicate a customer request selection. Assume that the request identifies the selection of a general feeder and two motor feeders. In such an example, the processing circuit 22 is then operable to generate a schematic of a switchgear system that includes the selected general feeder and two motor feeder subsystems.

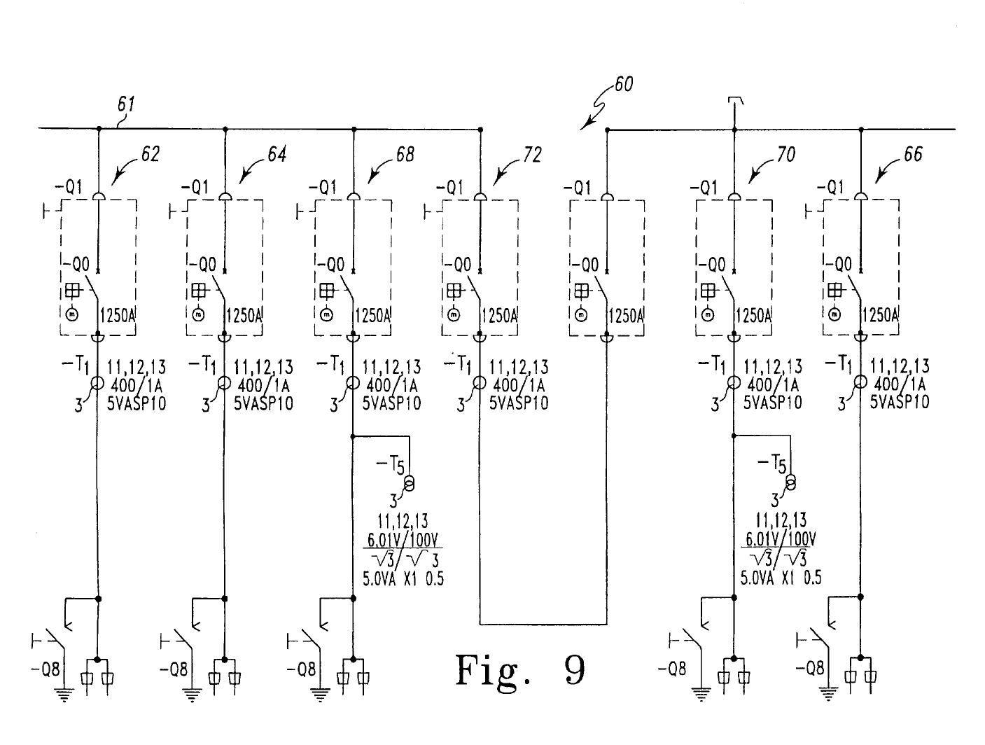

To generate the schematic information, the processing circuit 22 retrieves from the memory 20 the stored schematic data for each of the selected subsystem types and formulates a schematic file by “connecting” the schematic data for the selected subsystems into a single system schematic. In accordance with the present invention, the schematic data for each subsystem is configured to connect to a single line incoming voltage conductor (See, e.g., single line conductor 61 of FIG. 9). Accordingly, the schematic data for several subsystems may be connected via the single line.

The schematic data comprises data, that when displayed using a compatible graphics software package, shows the various subsystems in schematic form connected to each other to form a system schematic. (See, e.g., FIG. 9).

The memory 20 is preferably further configured to stored cost information pertaining to the subsystems. Such cost information may include cost information for individual elements within each subsystem. In particular, each subsystem comprise a number of individual elements such a current transformers, breakers, indicator lights, cabinets, and so forth. Cost information may be stored for such individual components, or alternatively for subassemblies or entire subsytems.

The processing circuit 22 is likewise preferably operable to generate a system cost using the cost information stored in the memory 20. In particular, after the switchgear system is defined, the processing circuit 22 generates the cost of the completed system, or system cost. Preferably, the processing circuit 22 generates the system cost by accumulating the individual costs of each component associated with each selected subsystem within the completed system. As discussed above, accumulating the costs of individual components, as opposed to using a blanket flat cost for each subsystem, allows for flexible costing to accommodate custom configurations defined by the customer-user. However, if such flexibility is not necessary or desirable, the costing may alternatively occur at the subsystem level. In such a case, the processing device would merely accumulate the subsystem costs for all of the subsystems in the completed system.

In addition, the processing circuit 22 may further factor into the system cost one or more discounts, such as those based on customer identification and/or quantities to be purchased. For example, a discount based on customer identification may be used to carry out previously-negotiated contract terms with a particular customer. A discount based on quantity may be used to encourage volume purchases.

The processing circuit 22 is also preferably operable to receive a purchase signal that is indicative of an operator's desire to purchase the specified system. The processing circuit 22 is further operable to complete a purchase order transaction electronically. Methods of completing a purchase order via the Internet or other network are known.

One of the benefits of the above described invention arises from the operator's ability to select components of a switchgear system, view the schematic of the selected system, obtain cost estimates of the system and to order the system. Such capability can reduce if not eliminate involvement by sales professionals, and can also limit the involvement of the application engineer of the switchgear provider.

The system 10 is preferably coupled to remote systems via the Internet 18, such as remote systems 12, 14 and 16, to allow an operator to generate remotely the signals indicative of the subsystem selections.

The system 10 includes a local user interface 10a that allows for local supervisory control and/or maintenance of the system 10. In addition, the user interface 10a may be configured to allow an operator to generate locally the signals indicative of selections of switchgear subsystem types.

To facilitate remote communications, the communication circuit 24 is any suitable, well known circuit that effectuates communication between the processing circuit 22 and remote systems coupled to the Internet 18. For example, the communication circuit 24 may include one or more telephone or cable modems, DSL devices, T1 interfaces, or a combination of the above. In a non-Internet network, the communication circuit 24 is likewise any suitable circuit that provides access to such network. In the preferred embodiment described herein, the processing circuit 22 and the memory 20 allow remote input and provide remote output via a hosted website as is known in the art.

The first remote system 12 includes a first remote processing device 26, a first remote communication circuit 28 and a remote user interface 30. The first remote system 12 may suitably be an Internet-capable general purpose computer system. Accordingly, the first remote processing device 26 may suitably include a microprocessor and related circuitry.

The first remote communication circuit 28 provides a communication connection between the first remote processing device 26 the internet 18. To this end, the first remote communication circuit 28 may suitably include one or more modems, DSL devices, T1 connections or the like.

The first remote user interface 30 is operable to communicate to a human operator information received from the first remote processing device 26. The user interface 30 is further operable to obtain input information from a human operator and provide signals representative of the input to the first remote processing device 26. To this end, the first remote user interface 30 may suitably include a keyboard, a mouse or other input device, a display and/or a printer.

The first remote processing device 26 is operable to receive input signals from the first remote user interface 30 and generate suitable corresponding signals for transmission over the Internet 18 by the first remote communication circuit 28. The first remote processing device 26 is also operable to receive signals from the Internet 18 via the first remote communication circuit 28 and provide corresponding information to the first remote user interface 30 for communication to the human operator. In general, such systems are widely known and may take the form of any Internet-capable device with a suitable user interface.

The first remote system 12 may suitably be located at the facilities of prospective switchgear customer. For example, the first remote system 12 may be located at a headquarters facility of a company that is building an industrial facility at another location. Accordingly, in such an example, the switchgear customer may use the first remote system 12 to identify, cost, and/or purchase switchgear through the system 10 over the Internet 18 without leaving the customer's premises.

The second remote system 14, similar to the first remote system, includes a second remote processing device 36, a second remote communication circuit 38 and a second remote user interface 40. The second remote system 14 preferably has the same general structure and capabilities as those of the first remote system 12. The third remote system 16 is also similar in structure and capabilities to the first and second remote systems 12 and 14.

The second and third remote systems 14 and 16 may each be located at the facilities of a different customers purchasing switchgear. Alternatively, one of the remote systems 12, 14 and 16 may be used by a sales professional affiliated with the switchgear manufacturer. In other words, a sales professional such as a manufacturer's representative may use the system 10 from the sales professional's office or premises.

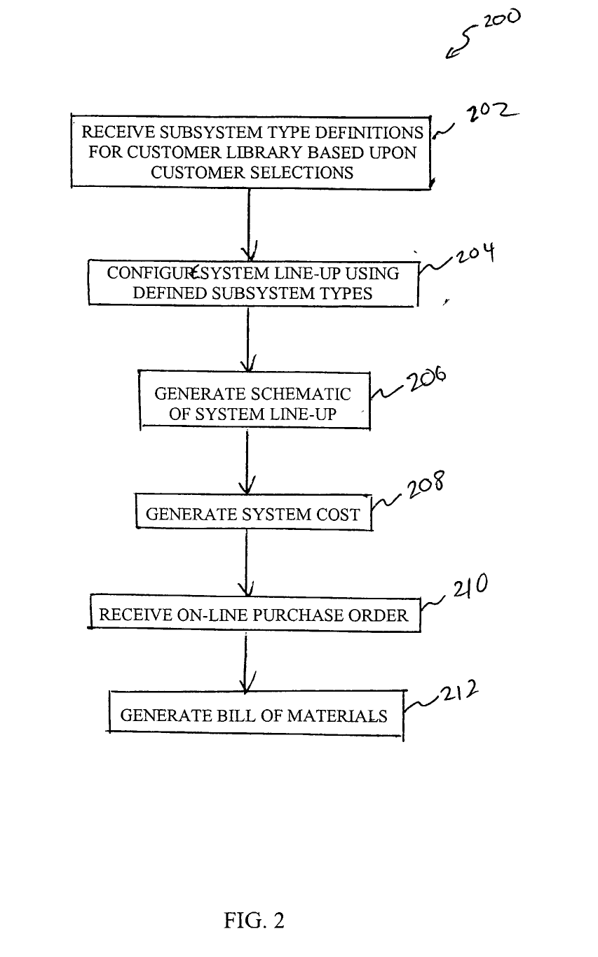

FIG. 2 shows a generalized flow chart of the operations of the processing circuit 22 of the system 10 of FIG. 1 in accordance with embodiments of the present invention. The flow chart of FIG. 2 represents an interaction with a customer or user, who provides input via one of the remote systems 12, 14 or 16. As discussed above, the processing circuit 22 may suitably prompt the user to enter various information using a web-site that allows user selection via graphical user interface menus, buttons, or the like. Alternatively, other common methods of prompting for and receiving remote user input may be employed.

First, in step 202, the processing circuit 22 receives input defining a library of subsystem types for the customer. In particular, the customer is prompted to select from a plurality of generic subsystem types and to specify one or more customer-specific parameters. The resulting subsystem, referred to herein as the defined subsystem type, represents a customer-configured version of a generic subsystem type. When the customer is done, the defined subsystem type is named and stored in the memory 20 as a part of the customer's subsystem library. As such, when the customer performs the system line-up definition, in step 204, the customer may repeatedly add the defined subsystem type without redefining each of the customer-specific parameters each time it is added.

The processing circuit 22 continues to prompt the customer to configure additional defined subsystem types for the customer's library until it receives input from the customer that the customer has completed defining its library of subsystem types.

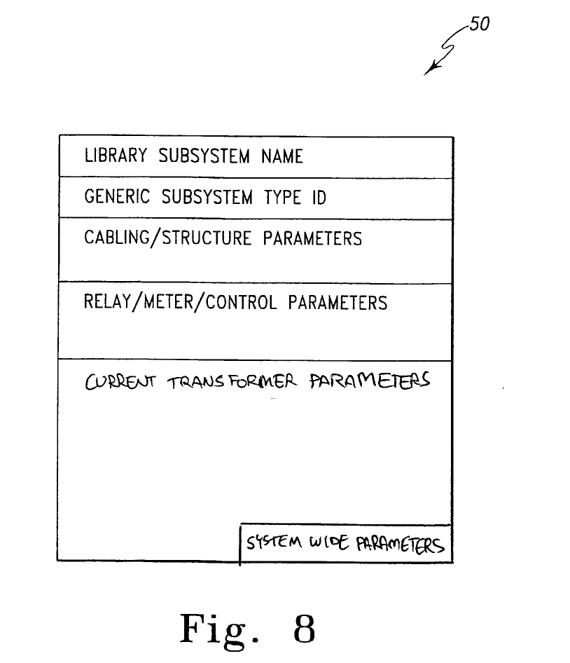

FIG. 8, discussed further below, shows a block diagram representation of a defined subsystem type data file 50 as it could appear in the library stored in the memory 20. The defined subsystem type data file 50 includes information identifying 1) the generic subsystem type (e.g. incoming feeder, motor feeder, transformer feeder, tie breaker), 2) customer-selected structure options (box size or shape options), 3) customer-selected bus/cabling options, (where cabling enters box, termination type, primary cable size, cables per phase), 4) customer-selected relay/meter/control options (relay selection options, meters to be included, type of controls for relays), 5) customer-selected current transformer options (quantity, turns ratio for each, stated accuracy for each, number of cores for each), 6) system parameters (voltage class, rated current).

The options that are available vary in accordance with the generic subsystem type. For example, the options available on a transformer feeder are different from those available on an incoming feeder. Accordingly, the memory 20 preferably further includes an options rule base for each generic subsystem type. After the customer identifies the subsystem type to define, the processing circuit 22 uses the corresponding rule base to query the customer to select from the available options (i.e. parameters). Once complete, the result is the defined subsystem type that is stored in the customer's subsystem library.

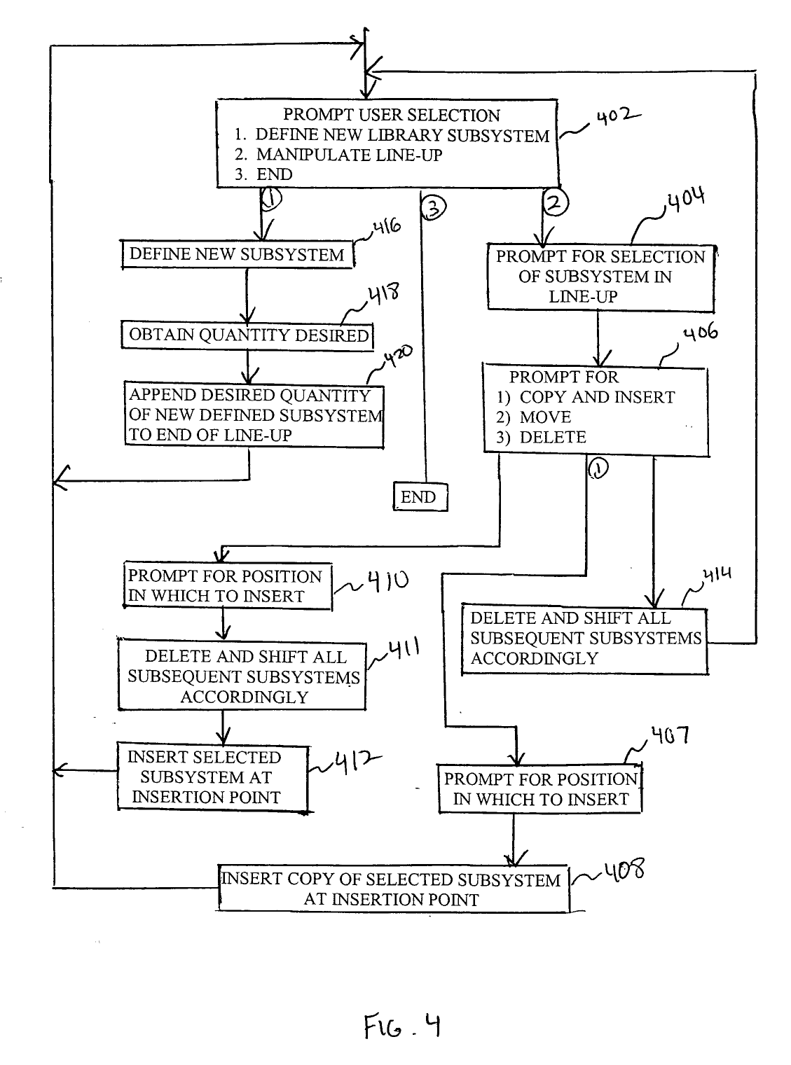

Referring again to FIG. 2, the processing circuit 22 may execute step 204 as long as at least one library subsystem has been defined. In step 204, the processing circuit 22 receives input from the customer identifying the system line-up. The system line-up identifies all of the defined subsystem types that together form the switchgear system. The system line-up also includes information identifying the order or sequence of the subsystem types. Note, by way of example, the sequence of subsystems 62, 64, 68, 72, 70 and 66 of the system line-up shown in FIG. 9. The system line-up is then stored as a data file. In the exemplary embodiment described herein, steps 202 and 204 may occur concurrently, with each new library subsystem defined in step 202 being automatically added to the end of the existing system line-up in step 204 by default. (See, e.g., steps 416-420 of FIG. 4). In the exemplary embodiment described herein, step 204 also permits the user to modify or manipulate the system line-up.

However, in an alternative embodiment, steps 202 and 204 are performed somewhat more sequentially. In such an embodiment, the processing circuit 22 would proceed to step 204 when the processing circuit 22 receives input indicating that the customer no longer desires to configure additional subsystem types in step 202. During step 204, the processing circuit 22 would receive input from the user identifying the sequence of defined subsystem types that make up the desired system line-up.

Once the system line-up is completed in step 204, the processing circuit 22 proceeds to step 206. It will be appreciated, however, that the customer is provided the option to return and modify the system line-up even after performing steps 206 or 208. In step 206, the processing circuit 22 generates a display of a schematic of the defined system. To this end, the processing circuit 22 generates a composite schematic of the individual schematics of the defined subsystem types that are identified in the system line-up. Information sufficient to generate each of the individual subsystem schematics is stored within each defined subsystem type data file 50.

To generate the composite schematic, the processing circuit 22 connects the individual schematics of the defined subsystem types at standard points, for example, at the single line input power conductor or bus. The resulting schematic is generated as graphic information that is preferably displayable on commonly available Internet browser software resident on the remote systems 12, 14 and 16. The generated schematic graphic information is then transmitted by the processing circuit 22 to the remote system 12, 14 or 16 at which the user is located. However, it will be appreciated that instead of transmitting the data using the Internet browsing function, the schematic graphic information may be transferred to the user as a file via electronic mail software.

In addition, or in the alternative, the processing circuit 22 may optionally have the capability to generate mechanical drawings for the defined system. For example, the mechanical drawings may include a floor plan of the defined system and/or a plan view of the defined system. Similar to the system schematic, the processing circuit 22 generates the mechanical drawings by combining the mechanical drawing information of each of the individual subsystems that are identified in the system line-up. Again, information sufficient to generate each of the individual subsystem floor plan and/or plan view drawings is stored within each defined subsystem type data file 50.

In any event, in addition to displaying the schematic information in step 206, the processing circuit 22 generates pricing information for the defined system line-up in step 208. To this end, the processing circuit 22 may accumulate the component prices for each component in the defined system line-up. Component pricing information for each subsystem of the system line-up is either stored within the data file 50, or may simply be derived from information within the data file 50.

For example, each generic subsystem type may have an overall price associated therewith. The generic subsystem type price may be modified by the options selected by the user during the definition of the library subsystem type during step 202. The final subsystem price may be stored as part of the library subsystem type data file 50 during step 202, or may be generated by the processing circuit 22 during step 208 based on the option and generic system type information in the data file 50.

Alternatively, the processing circuit 22 may first generate an overall component list consisting of the components in each subsystem. The component list would be generated based again on the generic subsystem type and option information in the library subsystem type data file 50 for each subsystem in the system line-up. The overall system price would then be based on the total of the all of the individual components of all of subsystems identified in the system line-up.

In any event, regardless of which method is used to derive the cost, the cost of the each subsystem may be generated using information from the defined subsystem type data file 50 stored in the customer's library.

The processing circuit 22 is preferably configured to generate pricing information responsive to a request from the user. Similarly, in step 206, the processing circuit 22 only generates and displays system schematic information responsive to a request from the customer. Accordingly, in some customer sessions, step 206 and/or step 208 are not necessarily performed. Moreover, as discussed above, after pricing and/or obtaining schematic information, the customer is provided the option of returning to step 204 to modify the system line-up or step 202 to configure additional defined subsystem types.

In step 210, the processing circuit 22 is operable to, responsive to customer input, accept a purchase order electronically. Various security features, order verification features and other safeguards that are normally associated with large scale business to business electronic transactions over the Internet may be implemented. Such elements are known in the art.

After accepting a purchase order electronically, the processing circuit 22 in step 212 preferably generates a bill of materials. As with the other elements, the bill of materials may readily be generated by accumulating bill of material information for each of the subsystems identified in the system line-up. The bill of material information may be standardized for each generic subsystem type. In addition, the processing circuit 22 may executed rules from a rule base that modifies the bill of material information based on the options defined in the subsystem type data file 50 for each user-defined subsystem.

The purchase order specifics, including the system line-up data file and/or the bill of materials, are transferred to an order processing function 44 of the switchgear sales entity. The order processing function 44 includes the normal enterprise accounting and purchase order tracking software that is used to perform normal purchase order processing operations.

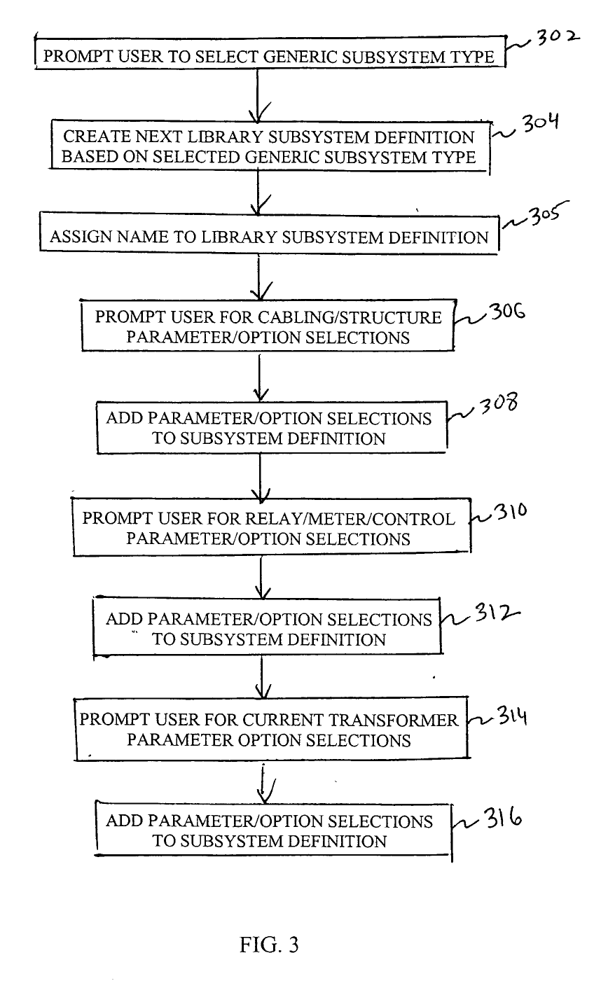

While the above describe steps may be carried out in a variety of ways and enjoy many of the benefits of the present invention, FIGS. 3-5 show exemplary embodiments of certain steps of the flow diagram of FIG. 2 that may be employed.

FIG. 3 shows an exemplary operation of the subsystem library definition of step 202 in FIG. 2. Again, FIG. 3 is explained in the context of a user (i.e. a customer or salesperson), located at one of the remote systems 12, 14 or 16, providing input to, and receiving output from, the processing circuit 22 via the communication circuit 24 and the Internet 18.

In step 302, the processing circuit prompts the customer to select a generic subsystem type on which the new “custom” or library subsystem type will be based. The available generic subsystem types would typically include incoming feeder, motor feeder, transformer feeder, tie breaker, auxiliary, as well as others. FIGS. 6 and 7 show exemplary schematic representations of generic subsystem types.

Referring again to FIG. 3, the processing circuit 22 receives input from the user identifying the generic subsystem type upon which the current subsystem type definition will be based. Thereafter, in step 304, the processing circuit 22 creates the next library subsystem definition based on the selected generic subsystem type. To this end, the processing circuit 22 creates a new data file 50 and adds information identifying the selected generic subsystem type to the created data file 50.

The processing circuit 22 further stores or otherwise identifies system wide parameters such as system voltage and rated current. The system wide parameters do not typically change for any of subsystems defined by the user. The processing circuit 22 may suitably prompt the user for such information concurrently with or before the definition of the first library subsystem type. Once defined, the system wide parameters may be stored in the data file 50 of each user-defined subsystem, as the system wide parameters will affect costs, materials, and options of each subsystem.

In any event, in step 305, the processing circuit 22 assigns a name to the new subsystem definition. The processing circuit 22 may automatically generate a subsystem name, or may alternatively prompt the user or customer to provide a name as input. In either event, the library subsystem name is stored in the data file 50.

After step 305, the processing circuit 22 proceeds to step 306. In step 306, the processing circuit 22 prompts the user to select from the structure and cabling options that are available for the selected generic subsystem type. The cabling options and structure options relate to physical elements of the subsystem, for example, where the cable is fed, what type of terminations are use (compression or mechanical), the size of the primary cable, and/or the number of cables per-phase. In some embodiments, the cabling and structure options may includes options on the size and/or configuration of the physical cabinet. Nevertheless, each switchgear provider will necessarily have a limited number of physical structure-related options in order to streamline manufacture and assembly, and to ensure modularity. In some cases, few or no options may be available.

As discussed above in connection with FIG. 2, there exists a set of rules identifying the available options associated with each generic subsystem type. Thus, to carry out step 306, the processing circuit 22 employs such rules to prompt the user for one or more entries identifying the customer's selection of cabling and structure options. The options may be presented to the customer via a pull-down menu, or a check-the-box screen, or other suitable user interface technique for obtaining a user selection. Once the structure and cabling options are selected, the processing circuit 22 in step 308 stores information identifying the selected structure and cabling options in the defined subsystem type data file 50.

After step 308, the processing circuit 22 proceeds to step 308. In step 308, the processing circuit 22 prompts the user to select from the relay/meter/control options that are available for the selected generic subsystem type. Such options relate primarily to various control aspects of the subsystem. For example, the customer may elect to employ a kilowatt hour meter or some other specialty meter within the subsystem. In another example, the customer may elect to include control related electronics such as indicator lights, a breaker control switch, remote control capability, breaker lockout, as well as others. The customer may also determine whether to include a protective relay for any of the selected meters and/or control devices. The precise options available for each generic subsystem type may vary for each switchgear provider.

Once the relay/meter/control options are selected, the processing circuit 22 stores information identifying the selected options in the defined subsystem type data file 50 in step 312.

After step 312, the processing circuit 22 proceeds to step 314. In step 314, the processing circuit 22 prompts the user to select from the transformer options available for the selected generic subsystem type. Transformer options include whether any current transformers are to be included, and if so, the quantity. If at least one current transformer is included, then the transformer options may allow the user to select from options pertaining to turns ratio, accuracy, and the number of cores for each transformer. Once the transformer options are selected, the processing circuit 22 stores information identifying the selected options in the defined subsystem type data file 50 in step 316.

After step 316, the definition of the current defined subsystem type is complete. It will be appreciated, however, the steps 304 to 316 may be performed in any order. Indeed, the customer may be allowed to define the option selections in steps 304 to 316 in an order dictated by the customer.

Multiple library subsystem types may be defined using the operations of FIG. 3. As will be discussed below in connection with FIG. 4, each defined subsystem is automatically added to the end of the system line-up in the exemplary embodiment described herein. However, it will be appreciated that the steps of FIG. 3 may suitably be employed in alternative embodiments, such as those in which the definition of the entire library of subsystems is complete prior to generating any portion of the system line-up. Such an alternative embodiment is described in further detail in U.S. Provisional Patent Application Serial No. 60/325,059, which is assigned to the assignee of the present invention and incorporated herein by reference.

Referring again to the exemplary embodiment described herein, FIG. 4 shows an exemplary set of operations that generally carries out the step 204 of FIG. 2. However, FIG. 4 also includes other operations that illustrated how step 202 and 204 interrelate in the exemplary embodiment described herein. In particular, the user has the option at any time to either define a new subsystem, which is automatically added to the end of the system line-up, or to modify or alter the existing system line-up. Steps 404-414 and step 420 generally make up the operations of step 204.

Referring now particularly to FIG. 4, in step 402, the processing circuit 22 allows the customer or user to choose from among a plurality of system line-up editing commands. In particular, the customer may choose to 1) define a new library subsystem; 2) manipulate an existing defined subsystem within the existing system line-up, or 3) end. It will be appreciated that the “end” selection may not be necessary because the user interface may contain selections that automatically end the system line-up definition step. For example, the processing circuit 22 may further provide the user with the option of generating a schematic file or generating a system cost. In such a case, if the customer elects to generate a schematic file (step 206 of FIG. 2) or generate a system cost (step 208 of FIG. 2), then the system line-up definition step will automatically end.

In any event, if the processing circuit 22 in step 402 receives an input indicative of a customer selection to define a new subsystem, then the processing circuit 22 proceeds to step 416. In step 416, the processing circuit 22 facilitates the user definition of a library subsystem. In general, step 416 may suitably be carried out by the collective operations of FIG. 3.

After the new library subsystem has been defined, the processing circuit 22 proceeds to step 418. In step 418, the processing circuit 22 prompts the user for the desired quantity of the new library subsystem to be added to the present system line-up. In other words, once the library subsystem is defined, multiple units of that subsystem may be employed within the system line-up. In step 420, the processing circuit 22 appends the desired quantity of the newly defined subsystem to the end (or bottom) of the system line-up.

Thus, in the exemplary embodiment described herein, the system line-up is automatically modified by default as each new subsystem is defined. However, to allow flexibility, the user or customer may modify the system line-up using the existing subsystems through manipulation of the subsystems within the existing system line-up. Such operations are enabled by the user selection of manipulating the system line-up in step 402.

In particular, if the processing circuit 22 in step 402 receives an input indicative of a customer selection to manipulate the existing system line-up, then the processing circuit proceeds to step 404. Such a selection may be carried out in a plurality of ways. For example, the user may simply select from a menu item that corresponds to manipulation of the system line-up. Alternatively, however, in connection with the embodiment described herein, the processing circuit 22 in step 402 preferably displays the entire system line-up, which will typically include all of the presently-defined library subsystems. In such a case, the customer or user may elect to manipulate the system line-up by highlighting or otherwise selecting one of the subsystems in the displayed system line-up.

In step 404, the processing circuit 22 may, if necessary, optionally prompt for the selection of the subsystem to be manipulated. In other words, if step 402 inherently includes a selection of an existing subsystem from the system line-up, as discussed above, then step 404 may be omitted and the processing circuit may proceed directly to step 406. However, if step 402 merely includes a user selection to generally manipulate the system line-up (without specifying any particular existing subsystem), then the processing circuit 22 in step 404 prompts the user for the identification of the subsystem of the system line-up to manipulate. In such a case, the user may suitably select the existing system from the displayed system line-up.

Thereafter, in step 406, the processing circuit 22 prompts the user for a command. The command may be to: 1) copy and insert the selected subsystem; 2) move the selected subsystem; and 3) delete the selected subsystem. If the user elects to copy and insert, then the processing circuit 22 proceeds to step 407. If the user elects to move, then the processing circuit 22 proceeds to step 410. If the user elects to delete, then the processing circuit 22 proceeds to step 414.

To copy and insert a subsystem, the processing circuit 22 in general inserts a copy of the selected subsystem at a position in the system line-up selected by the user. To this end, in step 407, the processing circuit 22 prompts the user for the position in the system line-up sequence in which to insert the new copy of the previously-defined subsystem type. As discussed above, the system line-up is preferably displayed, thus providing a means by which the user may define the position in which to insert the new subsystem. The processing circuit 22 would then receive input indicating the position in the sequence in which the copied subsystem type is to be inserted.

Thereafter, in step 408, the processing circuit 22 shifts down by one position all of the subsystems on the system line-up that are at or beyond the insertion position. The processing circuit 22 inserts the selected subsystem type at the insertion position on the list. The processing circuit 22 then returns to step 402 to receive the next user command.

To move a subsystem, the processing circuit 22, in general, removes the selected subsystem from its present position in the system line-up and inserts the selected subsystem at a position in the system line-up selected by the user. To this end, in step 410, the processing circuit 22 prompts the user for the position in the system line-up sequence in which to move the selected subsystem. The processing circuit 22 would then receive input indicating the position in the sequence in which the selected subsystem is to be inserted.

Thereafter, in step 411, the processing circuit 22 removes the subsystem from its present position in the system line-up by shifting up all of the subsystems on the system line-up that are below the present position of the selected subsystem. Such shift automatically removes the selected subsystem from that position. The processing circuit 22 then proceeds to step 412.

In step 412, the processing circuit 22 shifts down by one position all of the subsystems on the system line-up that are at or beyond the insertion position. The processing circuit 22 inserts the selected subsystem type at the insertion position in the line-up sequence. The processing circuit 22 then returns to step 402 to receive the next user command.

To delete the selected subsystem, the processing circuit 22 removes the selected subsystem from the system line-up. To this end, in step 414, the processing circuit 22 shifts up all of the subsystems on the system line-up that are below the position of the selected subsystem. Such shift automatically removes the selected subsystem from that position. The processing circuit 22 then returns to step 402 to receive the next user command.

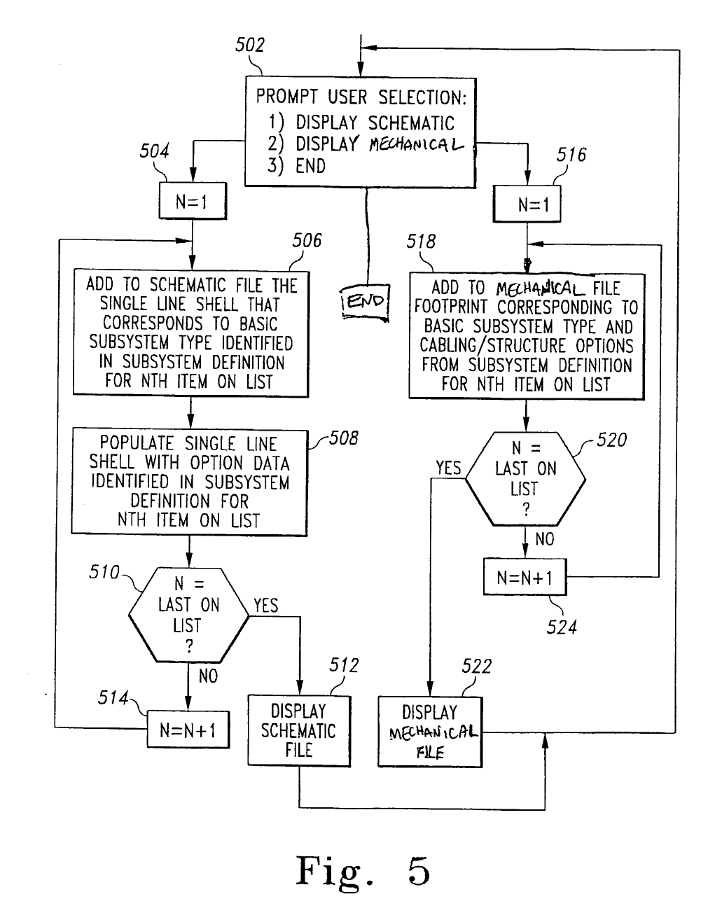

Referring again to step 402, if the processing circuit 22 receives user input identifying the “end” selection, the processing circuit 22 returns to the general operations of FIG. 2. As discussed above, it is possible that several options other than those of FIG. 4 may be available on a single interactive display screen. For example, all of the options for steps 202, 204, 206, 208 and 210 may be available on the same screen. In such a case, the “end” options of FIGS. 4 and 5 would not be necessary.

FIG. 5 shows an exemplary set of operations that may be used by the processing circuit 22 to display a schematic file of the defined system line-up. In addition, in the exemplary embodiment describe herein, the processing circuit 22 may be used to display a mechanical drawing of the structure of the system line-up. In the exemplary embodiment described herein, the mechanical drawing includes a floor plan of the system. The customer may use the mechanical drawings for the purpose of identifying or constructing appropriate space to accommodate the defined switchgear system.

In step 502, the processing circuit 22 prompts the user to elect to: 1) display/generate a schematic file; 2) display/generate a mechanical drawing file; or 3) end. If the user input indicates a selection to display/generate the schematic file, then the processing circuit 22 proceeds to step 504. If the user input instead indicates a selection to display/generate the mechanical drawing file, then the processing circuit 22 proceeds to step 516.

In step 504, the schematic display/generation operation begins with the processing circuit 22 setting an index n equal to 1. The index n relates to the subsystem number within the system line-up. After step 504, the processing circuit proceeds to step 506.

In step 506, the processing circuit adds to the current schematic file the single line shell schematic for the generic subsystem type identified in the defined subsystem type for the nth subsystem in the system line-up. In particular, each generic subsystem type, which is identified in each defined subsystem type data file 50 (FIG. 8), is associated with a single line shell schematic. The single line shell schematic of a switchgear subsystem typically includes the basic structure of the switchgear subsystem. The single line shell schematic also includes blanks or variables that are filled or defined in accordance with selected customer options.

For example, single line shell schematics 600 and 700 are shown in FIGS. 6 and 7 respectively. FIG. 6 shows a single line shell schematic 600 of a transformer feeder. The shell schematic 600 includes a bus bar 602 having a first connection 604 and a second connection 606, a branch bus 608 coupled to the bus bar 602. The branch bus 608 is also coupled to a branch supply conductor 610 through a breaker 605. The branch bus 608 includes standard elements and customer-option defined elements. Standard elements include a current transformer 612 and lightning protection circuit 614. Customer-option defined elements, represented by squares 616 and 618, include transformer option blocks 616 and 618. The option blocks 616 and 618 allow for flexibility to incorporate user specified current transformer options as generated in steps 310 and 314 of FIG. 3, discussed above. In particular, the option block 618 is provided to identify the specifics of the first current transformer 612, such as its turns ratio. The option block 616 identifies whether a second current transformer will be included, and if so, the specifics thereof.

FIG. 7 shows a similar shell schematic 700 of an incoming feeder. The incoming feeder shell schematic 700 includes a bus bar 702 having a first connection 704 and a second connection 706, a branch bus 708 coupled to the bus bar 702 and terminating in a branch supply conductor 710. The branch bus 708, similar to the branch bus 608 of FIG. 6, includes standard elements such as a breaker 705, a current transformer 712, a voltage transformer 714, and a lighting protection circuit 716, and further includes customer-option defined elements that are represented as empty squares 718, 720, and 722. The option block 718 is a second current transformer option block similar to option block 616 of FIG. 6, the option block 720 is a first current transformer (transformer 712) option block similar to option block 618 of FIG. 6, and the option block 722 is an option block for details regarding the voltage transformer 714, respectively.

Thus, FIGS. 6 and 7 show shell schematics of generic subsystem types. The data that is necessary to fill the option blocks 616, 618, 718, 720 and 722 is defined by the various option selections stored in the defined subsystem type data files 50.

To add the relevant shell schematic to the overall system schematics, the processing circuit 22 graphically connects the first connection (e.g. 604 or 704) of the bus bar (e.g. 602 or 702) to the second connection (e.g. 606 or 706) of the previous subsystem schematic. In this manner, several subsystems may be readily connected schematically if they include first and second bus bar connections. Typically, all subsystems will include first and second bus bar connections.

Referring again to FIG. 5, once a shell schematic associated with the generic or basic subsystem type of the nth item on the system line-up is added to the schematic file, the processing circuit 22 proceeds to step 508. In step 508, the processing circuit 22 populates the single line shell schematic with the option data identified in the subsystem definition associated with the nth item in the system line-up. Accordingly, the processing circuit 22 generates the schematic option data based on option information from the relevant defined subsystem type data file 50. Thus, several options or parameters defined in the data file 50 have predefined schematic data that is associated therewith.

For example, with reference to the shell schematics of FIGS. 6 and 7, the option blocks 618, 720 and 722 may merely be populated with text that identifies the various transformer details. By contrast, the option blocks 616 and 718 may be populated with graphical elements representative of whether or not a second current transformer has been specified. For example, in either case, if a second transformer is to be included, then a vertical line with a circle is inserted into the block, the line representing the branch bus 608 connection and the circle representing the second transformer. If, however, a second transformer is not to be included, then only the vertical line is to be inserted, representing the branch bus connection 608 only.

After the shell schematic generated in step 506 is modified by the option data in step 508, the processing circuit 22 proceeds to step 510. In step 510, the processing circuit 22 determines if the nth item is the last item on the system line-up list. If so, then the processing circuit 22 may display the schematic file in step 512. Alternatively, or in addition, the processing circuit 22 may transfer the schematic file to the customer via electronic mail. Once the display or transfer is complete, the processing circuit returns to step 502 and awaits the next user command.

If, however, in step 510, the processing circuit 22 determines that the nth item is not the last item on the system line-up list, then the processing circuit 22 increments n in step 514 and returns to step 506. FIG. 9, discussed further below, shows an exemplary schematic diagram that may be generated in accordance with the above described steps. However, it will be appreciated that the system may be modified by those of ordinary skill in the art to generate other schematics, such as more detailed schematic diagrams of the system.

Steps 516-524 relate to the generation of a system mechanical drawing file. In general, the system mechanical drawing file includes, among other things, a system floor plan. A system floor plan is a top plan view of the entire system. Floor plans are useful in determining layout of the system within a building or other structure of the facility in which the system will be used. It will be appreciated, however, the concepts described below may readily be employed to generate other mechanical drawings, for example, a front plan view drawing of the system.

In step 516 (customer selection of generate/display mechanical drawing), the processing circuit 22 sets the index n equal to 1. As with the schematic file generation process discussed above, the index n relates to the subsystem number within the system line-up. After step 516, the processing circuit 22 proceeds to step 518.

In step 518, the processing circuit 22 adds the subsystem floor plan for the nth subsystem to the system mechanical drawing file. The subsystem floor plan includes a plan view blueprint for the generic subsystem type, as modified by the cabling/structure options specified in the defined subsystem type. In particular, each basic or generic subsystem type, which is identified in each library subsystem definition data file 50 (FIG. 8), is associated with one or more standard plan view blueprints. For example, the standard plan view blueprint may be a top plan view showing the floor space “footprint” of the subject subsystem. In the exemplary embodiment described herein, each basic subsystem type corresponds to one or a few plan view footprints, each specific to one of the available cabling/structure options. Thus, using the generic subsystem type and the cabling/structure option information from the data file 50 of FIG. 8, the processing circuit 22 can generate at least a rough floor plan view of each subsystem.

The processing circuit 22 may suitably add subsystem floor plans from left to right in the system floor plan. In this manner, the switchgear subsystems are aligned in a linear fashion. However, provision may be made for the user to form rows of subsystems or some other alternative configuration.

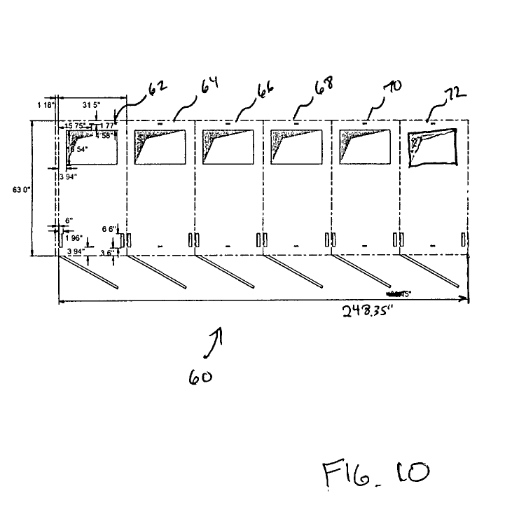

After step 518, the processing circuit 22 proceeds to step 520. In step 520, the processing circuit 22 determines whether the nth item is the last item on the system line-up list. If so, then the processing circuit 22 may display the system floor plan file in step 522. Alternatively, or in addition, the processing circuit 22 may transfer the system floor plan file to the customer via electronic mail. Once the display or transfer is complete, the processing circuit 22 returns to step 502 and awaits the next user command. FIG. 10, discussed below, shows a floor plan view of a system generated in accordance with the present invention.

If, however, in step 520, the processing circuit 22 determines that the nth item is not the last item on the system line-up list, then the processing circuit 22 increments n in step 524 and returns to step 518.

FIG. 9 show an exemplary schematic representation of a schematic data file configured in accordance with system 10 of FIG. 1. The schematic representation shows a defined switchgear system 60 having a single line conductor or bus bar 61 and a plurality of subsystems 62, 64, 66, 68, 70, and 72. Each of the subsystems 62, 64, 66, 68, 70 and 72 comprises one of four defined subsystem types within the customer's library. In particular, the exemplary switchgear system 60 of FIG. 9 includes a transformer feeder subsystem 62, two motor feeder subsystems 64, 66, two incoming feeders 68, 70 and a tie breaker 72. Described below is an exemplary execution of the flow diagram 200 of FIG. 2 that maybe used to construct the schematic data of the switchgear system 60 of FIG. 9.

First, in steps 202 and 204, the customer defines via the system 10 four subsystem types for the customer's library, and implements the subsystem types in a desired system line-up. The defined subsystem types include an incoming feeder, a motor feeder, a tie breaker, and a transformer feeder. During this process, the customer selects from available options in order to configure the generic subsystem types into defined subsystem types that correspond to his/her particular needs. The customer may further define system wide parameters, such as a 1250 amp current rating.

Table 1 shows the system line-up, which may be generated using steps 202 and 204, and which corresponds to FIG. 9.

TABLE 1

| | |
|---|---|
| 1. | 1250 amp transformer feeder |
| 2. | 1250 amp motor feeder |
| 3. | 1250 amp incoming feeder |
| 4. | 1250 amp tie breaker |
| 5. | 1250 amp incoming feeder |
| 6. | 1250 amp motor feeder |

Thus, in the exemplary execution described herein, the customer may have suitably first defined the transformer feeder, which was automatically assigned to the first position in accordance with step 420 of FIG. 4. The customer may then have defined the motor feeder, incoming feeder and tie breaker in sequence. As a result, in accordance with step 420 of FIG. 4, those elements would have been assigned the next three positions in the system line-up. Thereafter, the customer may have used the copy and insert function (steps 407 and 408 of FIG. 4) to add the second incoming feeder and the second motor feeder to positions 5 and 6 of the system line-up.

In step 206, the processing circuit 22 generates the schematic data file that, when displayed or printed, shows the system 60 as it appears in FIG. 9. The schematic data file is displayed to the customer via the customer's user interface. Alternatively, the processing circuit 22 causes the schematic data file to be transmitted to the customer via an electronic mail message or the like.

In addition, the processing circuit 22 may additional generate the mechanical drawing file, shown in FIG. 10. As shown in FIG. 10, the mechanical drawing of the switchgear system 60 includes a separate cabinet for each of the subsystems 62, 64, 66, 68, 70, and 72. In this example, the floor plans of the individual subsystems 62, 64, 66, 68, 70 and 72 are largely identical. However, it will be appreciated that the process of generating the system floor plan is readily applicable a defined switchgear system in which the subsystem cabinets have different floor plans. The resulting mechanical drawing may be provided to the customer in the same manner as that which is used to provide the schematic data file to the customer, discussed above.

In step 208, the processing circuit 22 generates the system cost by identifying the cost for each item or the system line-up list. As discussed above, various pricing options may also be employed to generate the final system costs, including for example, quantity discounts.

In step 210, the customer may elect to execute a purchase order for the system 60. Upon execution of the purchase order, the processing circuit 212 uses the information from the data files 50 corresponding to each subsystem in the defined switchgear system to generate a bill of materials.

The above described operations may be carried out in alternative orders and still obtain many of the benefits of the present invention. It will be appreciated that the above described embodiments are merely illustrative, and that those of ordinary skill in the art may readily devise their own implementations that incorporate the principles of the present invention and fall within the spirit and scope thereof.

For example, many of the principles embodied herein will have application outside the switchgear purchasing field, particularly in fields having similar constraints and issues. Nevertheless, the principles described herein are particularly well-suited to switchgear purchasing transactions. In another example, it will be appreciated that the customer need not necessarily define a “library” of subsystems, but may rather individually create each new subsystem. In such a case, a new subsystem may be created by merely editing or copying an existing subsystem.

What is claimed:

1. A method of specifying an electrical switchgear system comprising:
providing a first signal to a first processing circuit indicative of a selection of a first switchgear subsystem type from a plurality of switchgear subsystem types;
providing a second signal to the first processing circuit indicative of a selection of a second switchgear subsystem type from the plurality of switchgear subsystem types;
updating a schematic file by incorporating first switchgear subsystem schematic data and second switchgear subsystem schematic data.

2. The method of claim 1 further comprising generating a display of a schematic diagram of the electrical switchgear system from the updated schematic file.

3. The method of claim 1 wherein providing the first signal further comprises providing the first signal from a remote processing circuit.

4. The method of claim 2 wherein providing the first signal further comprises providing the first signal from a remote processing circuit.

5. The method of claim 1 wherein updating the schematic file further comprises updating the schematic file using the first processing circuit.

6. The method of claim 1 further comprising providing a third signal to the processing circuit indicative of an election to purchase the electrical switchgear system.

7. The method of claim 1 further comprising employing the first processing circuit to generate a system price responsive to the first signal and the second signal.

8. The method of claim 1 further comprising defining the first switchgear subsystem type using a generic subsystem type and user configuration information.

9. A method of specifying an electrical switchgear system comprising:
providing a first signal to a first processing circuit indicative of a selection of a first switchgear subsystem type from a plurality of switchgear subsystem types;
providing a second signal to the first processing circuit indicative of a selection of a second switchgear subsystem type from the plurality of switchgear subsystem types;
employing the first processing circuit to generate a system price responsive to the first signal and the second signal.

10. The method of claim 9 further comprising generating a display of a schematic diagram of the electrical switchgear system from a schematic file, the schematic file including first switchgear subsystem schematic information and second switchgear subsystem schematic information.

11. The method of claim 10 wherein providing the first signal further comprises providing the first signal from a remote processing circuit.

12. The method of claim 9 wherein providing the first signal further comprises providing the first signal from a remote processing circuit.

13. The method of claim 9 further comprising providing a third signal to the first processing circuit indicative of an election to purchase the electrical switchgear system.

14. The method of claim 9 further comprising defining the first switchgear subsystem type using a generic subsystem type and user configuration information.

15. A system for facilitating the selection of electrical switchgear, the system comprising:
a memory storing schematic data for a plurality of switchgear subsystem types;
a processing circuit operably coupled to the memory, the processing circuit operable to:
receive a first signal indicative of a selection of a first switchgear subsystem type from the plurality of switchgear subsystems;
receive a second signal indicative of a selection of a second switchgear subsystem from the plurality of switchgear subsystems;
update a system schematic file using schematic data for the first switchgear subsystem type and schematic data for the second switchgear subsystem type.

16. The system of claim 15 further comprising a display operably coupled to the processing circuit, the display operable to display a schematic diagram representative of the system schematic file.

17. The system of claim 16 wherein the display comprises a remote display, and the system further comprises a remote processing circuit operably coupled between the remote display and the processing circuit.

18. The system of claim 17 wherein the remote processing circuit is operable to provide the first signal.

19. The system of claim 15 further comprising a remote processing circuit operable to provide the first signal.

20. The system of claim 15 wherein the processing circuit is further operable to receive a third signal indicative of an election to purchase the first and second switchgear subsystems.

21. The system of claim 15 wherein the processing circuit is further operable to generate a system price responsive to the first signal and the second signal.

22. The system of claim 15 wherein the processing circuit is further operable to receive a configuration signal, the configuration signal further including information indicative of first switchgear subsystem parameters.
